(19) United States
(12) Patent Application Publication
(10) Pub. No.: US 2004/0070610 A1
(43) Pub. Date: Apr. 15, 2004

(54) Configuration method of apparatus, and communication terminal device using the method

(75) Inventor: Yoshifumi Tanimoto, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Murata Kikai Kabushiki Kaisha, Kyoto-shi (JP)

(21) Appl. No.: 10/656,114

(22) Filed: Sep. 8, 2003

(30) Foreign Application Priority Data
Sep. 27, 2002 (JP) 2002-283665

(51) Int. Cl. G09G 5/00

(52) U.S. Cl. 345/751

(57) ABSTRACT

A communication terminal loads a screen file necessary for forming a configuration screen from other than the apparatus body which is the subject of the configuration. Following the configuration screen, a user enters configuration data and information, which specifies the destination for transmitting the data. The communication terminal transmits the entered configuration data to an apparatus of the designated destination. A FAX machine receives the configuration data and executes a configuration process. As a result, it becomes unnecessary to provide a memory field for storing the screen file in the apparatus body that is the subject of the configuration.

### FIELD OF THE INVENTION

The present invention relates to information processing technology, and especially to technology for configuring a prescribed apparatus via a network.

### DESCRIPTION OF THE RELATED ART

Accompanying the development of network technology, information apparatus such as a printer, a scanner, a facsimile machine, a Multi Function Peripheral (MFP) or the like, having the function of establishing a connection with a network are becoming widespread. To use these information apparatus, it is necessary for a user to previously set in the apparatus data, such as an Internet Protocol (IP) address or a name for uniquely identifying these apparatus on the network. Such a configuration operation is carried out directly by using key buttons, a display unit or the like of the apparatus, or carried out indirectly by using a web browser from a computer that is connected to the network.

To carry out the configuration operation under the latter method, for example, an information apparatus includes a function as a Hyper Text Transport Protocol (HTTP) server, which stores a Hyper Text Markup Language (HTML) file (hereinafter referred to as the “screen file”) for displaying a configuration screen on a computer of the user (hereinafter referred to as the “client”), presents a designated screen file to the client according to a request from the client, and receives data entered by the client.

Compared to a client terminal, such as a general-purpose computer, which includes a storage device such as a hard disk or the like having a large capacity, the total capacity of a storage device of an information apparatus, which is an embedded typed apparatus not having a hard disk, is small. Therefore, the capacity among the total capacity, which can be used for saving screen files, becomes considerably small. However, accompanying improvements in the functions of the information apparatus, the number of items to be configured for the apparatus increases. When the number of items increases, the amount of data of the screen files also increases, and the number of the screen files also increases. In addition, to present a user-friendly configuration screen, it is necessary to add notices or the like on the screen for the entering operations, and it is also necessary to devise the layout of the screen. However, this also contributes to increase the amount of data in the screen files.

### SUMMARY OF THE INVENTION

The present invention was made in consideration of the above-described problems. An objective of the present invention is to provide technology for presenting a user-friendly configuration screen, technology for efficiently using a storage device of an information apparatus, and technology for facilitating the distribution of a screen file to the user.

One of the aspects of the present invention is a communication terminal device. The communication terminal device includes an accepting unit, an entry unit, a destination accepting unit, and a transmission unit. The accepting unit accepts a file for displaying a configuration screen having data entry fields. The entry unit enters data to a data entry section for configuring a prescribed apparatus. The destination accepting unit accepts information, which specifies the prescribed apparatus intended to set data as destination identification information. The transmission unit transmits the data to the apparatus specified by the destination identification information. Accordingly, it becomes unnecessary for the apparatus intended to be set to store a screen file for displaying a configuration screen. The “destination identification information” is information for specifying an apparatus on a network, such as an electronic mail address of an electronic mail message, an IP address, a Uniform Resource Locator (URL) or the like which can be acquired by the apparatus.

Another aspect of the present invention is a method for configuring prescribed data in a prescribed apparatus. The method includes a step for accepting a file for displaying a configuration screen to be used for configuring the prescribed apparatus. In addition, the method includes a step for accepting an entry of destination identification information, which is information for specifying an apparatus intended to be set by following the configuration screen. The method also includes a step for transmitting information, which is intended to be set by following the configuration screen, to an apparatus specified by the destination identification information.

Another different aspect of the present invention is an information system. The system includes a target apparatus which is connected to a network and which is a subject of a configuration, and a communication terminal device which transmits data necessary for the configuration to the apparatus. The communication terminal device includes an acquiring unit, an accepting unit, and a transmission unit. The acquiring unit acquires a file for displaying a configuration screen to be used for configuring the apparatus from a device that is different from the target apparatus. The accepting unit accepts an entry of destination identification information, which is information for specifying on the network a target apparatus that is to be set by following the configuration screen. The transmission unit transmits the data to the target apparatus specified by the destination identification information. A device which presents a file for displaying the configuration screen (hereinafter referred to as the “file presenting device”) can be a file server connected to a network, or a recording medium such as a Compact Disk-Read Only Memory (CD-ROM) or a flexible disk. In short, if the file presenting device can store the screen file, and the screen file is accessible from the communication terminal device, the file presenting device can be in any form, any format, or can be provided at any location.

Further, any combination of the above-described constituent elements, or a conversion of an expression of the present invention between a method, a device, a system, a recording medium, a computer program or the like is also effective as one of the aspects of the present invention.

According to the present invention, the screen file to be used for configuring an apparatus can be located at a remote location from the apparatus.

### BRIEF DESCRIPTION OF THE DRAWINGS

FIG. 1 is a block diagram showing an information system according to an embodiment of the present invention.

FIG. 2 shows an example of a configuration screen displayed at a communication terminal of FIG. 1.

FIG. 3 is a block diagram showing an inner configuration of the communication terminal of FIG. 1.

FIG. 4 is a block diagram showing an inner configuration of a FAX machine of FIG. 1.

FIG. 5 is a sequence diagram showing a sequence between each of devices in a series of configuration processing.

### DETAILED DESCRIPTION OF THE PREFERRED EMBODIMENTS

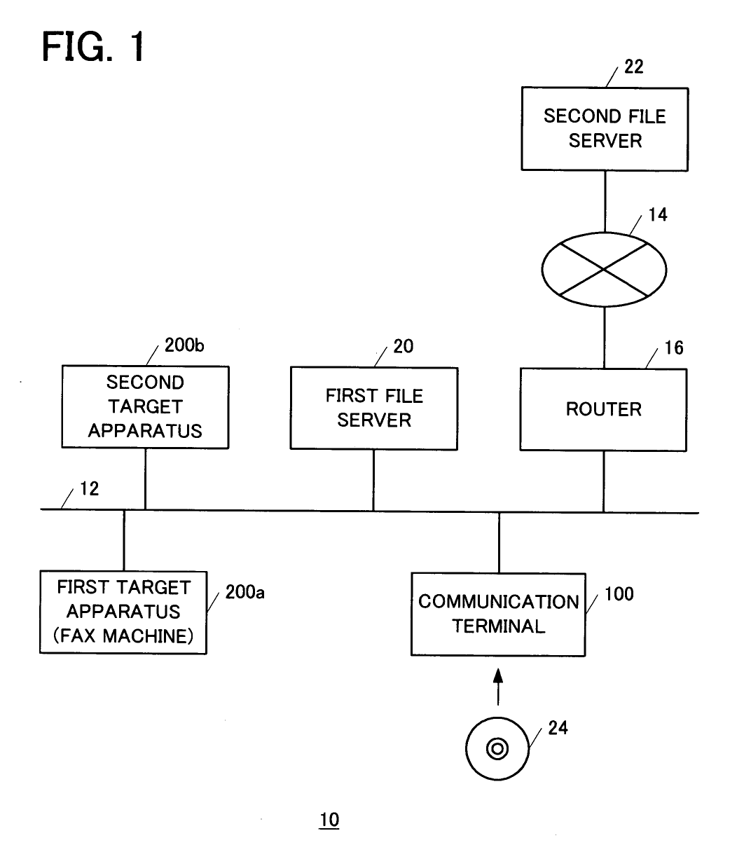

FIG. 1 is a block diagram showing an information system 10 according to an embodiment of the present invention. A first target apparatus 200a and a second target apparatus 200b are connected to a Local Area Network (LAN) 12. The first target apparatus 200a and the second target apparatus 200b are a device which includes a FAX function, a scanner function, a printer function, a printer server function, a FAX server function or the like, or a Multi Function Peripheral (MFP) which includes a plurality of these functions. In addition, the first target apparatus 200a and the second target apparatus 200b respectively include a function for accepting information such as an IP address or a subnet mask of the apparatus (hereinafter referred to as the “configuration data”, and information which specifies each of the configuration data will be referred to as the “data item”) via the LAN 12. In the present embodiment, with the first target apparatus 220a having a FAX function (hereinafter referred to as the “FAX machine 200a”) as an example, a configuration function of the FAX machine 200a will be described.

A communication terminal 100 is a terminal device such as a personal computer or a Personal Digital Assistant (PDA). The communication terminal 100 is connected to the LAN 12. The communication terminal 100 includes a browser which displays in accordance with a document description language such as HTML. A recording medium 24 is a recording medium such as a CD-ROM, a flexible disk, or a semiconductor memory. The recording medium 24 stores screen files to be used for configuring the FAX machine 200a. The screen files are formed in a document description language or a program language, such as an HTML, an extensible Markup Language (XML), Java (registered trademark) or the like, which can be displayed on the browser of the communication terminal 100.

The communication terminal 100 loads a screen file from the recording medium 24, and displays a configuration screen for the FAX machine 200a. For example, the configuration screen includes an entry field for entering configuration data to be set for the FAX machine 200a. Furthermore, the configuration screen includes an entry field for entering information which specifies a target apparatus which should set the entered configuration data (hereinafter referred to as the “destination identification information”).

The communication terminal 100 transmits the configuration data to a target apparatus specified by the destination identification information. As described above, since a destination of the configuration data can be designated by using the configuration screen, the screen file can be loaded from a remote location of the FAX machine 200a. Accordingly, it becomes unnecessary to provide a memory field in the FAX machine 200a for storing screen files. Furthermore, compared to the case in which the FAX machine 200a stores the screen file, an upper limit on an amount of data of the screen files can be increased. As a result, an explanation for each of the data items in the screen file can be presented in details like an operation manual by using figures, animations, configuration examples or the like. Accordingly, a user-friendly configuration screen can be presented.

The storage place of the screen file is not limited to the recording medium 24. The screen file can be stored in a first file server 20 which is connected to the LAN 12, or a second file server 22 which is provided in a wide area network 14 connected to the LAN 12 via a router 16. In short, the configuration file can be stored in any place if the communication terminal 100 can acquire the configuration file. Moreover, by adopting a form in which the screen file is presented from the first file server 20 or the second file server 22, a version of the screen file can be updated easily at a service center.

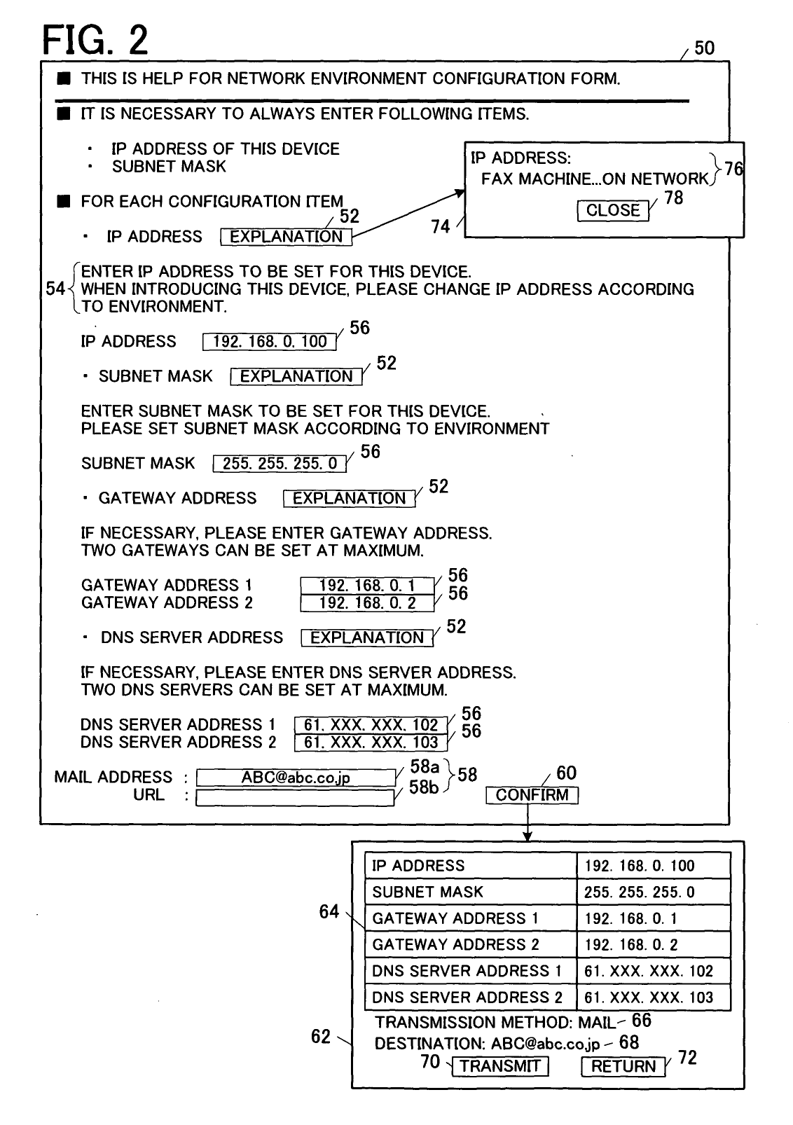

FIG. 2 shows an example of a configuration screen 50 displayed on the communication terminal 100. The configuration screen 50 is an example of a screen for configuring data items relating to a network environment. An entry field 56 is a field for entering configuration data. The entry field 56 is provided according to a number of the data items. A simplified description field 54 displays simple explanations relating to the data items, notices for the entering operation or the like. Moreover, a first button 52 is a button for instructing the display of a detailed explanation concerning the data item. When the user presses the first button 52, a detailed explanation display screen 74 is displayed as a sub-screen. A detailed explanation field 76 displays a detailed explanation as written in a general operation manual. Accordingly, the user can proceed with the configuration operation by referring to the detailed explanation. When pressing a second button 78, the sub-screen disappears from the screen.

A destination information entry field 58 is a field for entering the destination identification information that specifies the FAX machine 200a, which is a destination for transmitting the configuration data entered in the respective entry field 56. In FIG. 2, as the destination information entry field 58, there are an electronic mail address entry field 58a for entering an electronic mail address, and a URL entry field 58b for entering a URL. Moreover, entry fields for entering an IP address, a MAC address, the name of a device or the like can be provided as the destination information entry field 58.

A third button 60 is a button for instructing the display of a confirmation screen 62 of the entered contents. When the user presses the third button 60, the confirmation screen 62 is displayed. A list displaying field 64 displays the configuration data entered in the entry fields 56 by associating a list item with each of the data items. A transmission method displaying field 66 displays the transmission method of the configuration data. A destination information displaying field 68 displays the destination identification information. A fourth button 70 is a button for instructing the transmission of the configuration data to a device specified by the destination identification information. A fifth button 72 is a button for instructing the return of the configuration screen 50 when there is a mistake in the entry.

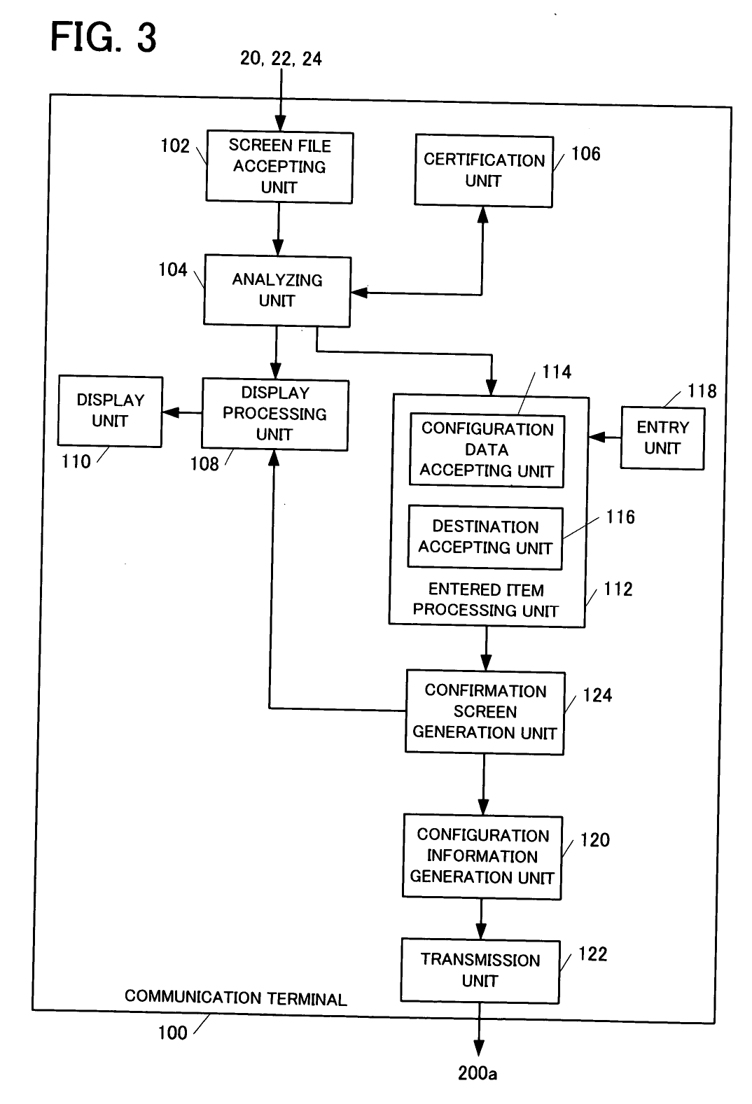

FIG. 3 is a block diagram showing an inner configuration of the communication terminal 100 of FIG. 1. When describing hardware components, each constituent element of the communication terminal 100 is realized primarily by a Central Processing Unit (CPU) of any computer, a memory, a program which realizes the constituent elements shown in FIG. 3 loaded to the memory, a storage unit such as a hard disk which stores the program, and an interface for establishing a connection with a network. It is understood by those skilled in the art that various changes and modifications can be made for methods and devices for realizing each of the constituent elements of the communication terminal 100. Each of the drawings to be described hereinafter shows blocks representing units of function instead of units of hardware.

A screen file accepting unit 102 acquires a screen file from either the first file server 20, the second file server 22, or the recording medium 24. An analyzing unit 104 analyzes the document description language or the program language included in the screen file. When it is necessary to certify the display on the configuration screen, the analyzing unit 104 requests certification of the user from a certification unit 106. The certification unit 106 carries out certification of the user by requesting an ID, a password or the like. Accordingly, a person not having proper authority can be prevented from changing the configuration data

A display processing unit 108 displays the configuration screen as shown in FIG. 2 on a display unit 110 according to the analysis made by the analyzing unit 104. An entry unit 118 is a device such as a keyboard, a mouse, or a touch panel, for accepting an entry made by the user. An entered item processing unit 112 accepts an entry of the configuration data or the like via the entry unit 118. The entered item processing unit 112 includes a configuration data accepting unit 114 and a destination accepting unit 116. The configuration data accepting unit 114 accepts the configuration data and temporarily stores the configuration data and the data item by associating one with the other. The destination accepting unit 116 accepts the destination identification information and temporarily stores the destination identification information and information which specifies a transmission method by associating one with the other. Specifically, data item names are respectively associated with the entry fields 56 and the destination information entry fields 58 described in FIG. 2. The configuration data accepting unit 114 and the destination accepting unit 116 store the configuration data entered by the user and the destination identification information by associating the data with the data item names.

A confirmation screen generation unit 124 newly generates a screen file for confirming and transmitting the entered configuration data (hereinafter referred to as the “confirmation screen file”). The confirmation screen file includes at least the configuration data associated with the data item, the destination identification information such as an electronic mail address or a URL, and information for designating a transmission method. In the present embodiment, an entry field of the destination identification information is provided for each transmission method as the destination information entry field 58 of FIG. 2. The confirmation screen generation unit 124 detects the presence or absence of an entry of the destination identification information in each entry field. Then, the confirmation screen generation unit 124 embeds into the confirmation screen file, information that designates a transmission method corresponding to the entered destination identification information. The information that designates the transmission method is embedded into the confirmation screen file as a tag or the like. As described above, the confirmation screen generation unit 124 can specify a transmission method desired by the user from a plurality of transmission methods. The transmission method specified as described above is displayed in the transmission method display field 66 of FIG. 2. The confirmation screen generation unit 124 supplies the generated confirmation screen file to the display processing unit 108. Accordingly, the confirmation screen 62 described by using FIG. 2 is displayed on the display unit 110. Specifically, the confirmation screen generation unit 124 is formed by a program language such as Java (registered trademark) included in the screen file.

A configuration information generation unit 120 generates configuration information to be transmitted to the FAX machine 200a in accordance with the configuration data and the destination identification information included in the confirmation screen file under a timing in which, for example, the fourth button 70 of FIG. 2 is pressed. When an electronic mail address is designated as the destination identification information, the configuration information generation unit 120 generates an electronic mail message including the configuration data. The configuration information generation unit 120 generates an electronic mail message including a character string, which the data item name and the configuration data are described by being associated with one another. Further, the data item name and the configuration data are described by using an XML or the like. When a URL is designated as the destination information, the configuration information generation unit 120 generates configuration information such that the configuration data can be transmitted based on HTTP format or the like.

The configuration information generation unit 120 can also generate a file including a character string which associates the data item name with the configuration data. In short, the configuration information generation unit 120 can generate configuration information in a format that is suitable for a plurality of transmission methods. The configuration information generation unit 120 determines a format of the configuration information to be generated selectively according to the destination identification information entered by the user. Then, the configuration information generation unit 120 generates the configuration information such that the configuration data and the data item name can be transmitted precisely. As another embodiment, the configuration information generation unit 120 can be formed to support only one of the transmission methods. A transmission unit 122 transmits the configuration information generated by the configuration information generation unit 120 to the FAX machine 200a designated by the destination identification information.

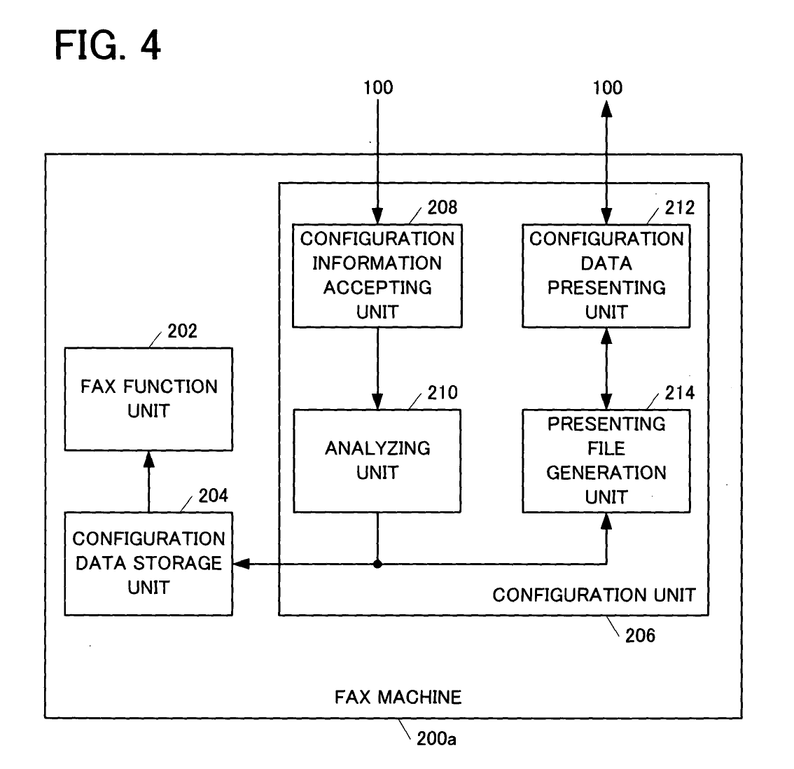

FIG. 4 is a block diagram showing an inner configuration of the FAX machine 200a of FIG. 1. A FAX function unit 202 is a unit which realizes a general FAX function such as transmission and reception of an original document. The FAX function unit 202 executes prescribed processing in accordance with configuration data stored in the configuration data storage unit 204. A configuration unit 206 receives the configuration information transmitted from the communication terminal 100, and stores the configuration data included in the configuration information in a configuration data storage unit 204.

A configuration information accepting unit 208 accepts the configuration information transmitted from the communication terminal 100 of FIG. 1. When receiving the configuration information in the form of an electronic mail message, the configuration information accepting unit 208 acquires the electronic mail message from a mail server. The electronic mail address can be registered at a time the FAX machine 200a is shipped, or can be registered optionally by the user afterward. When accepting the configuration information under a format based on HTTP, the configuration information accepting unit 208 functions as an HTTP server, and accepts the configuration information transmitted by GET command, POST command of the HTTP protocol or the like. The configuration information accepting unit 208 can also accept the configuration information under a format of a File Transfer Protocol (FTP). The configuration information accepting unit 208 can accept the configuration information selectively by any one of the formats, or can accept the configuration information by one of the formats. A format of the configuration information can be in any format. In short, the configuration information can be in any format if the FAX machine 200a can receive the configuration information via a network.

An analyzing unit 210 fetches the configuration data for each data item from the configuration information, and stores the configuration data in the configuration data storage unit 204. When a configuration data presenting unit 212 is requested to reference the already registered configuration data, the configuration data presenting unit 212 instructs a presenting file generation unit 214 to generate a file necessary for presentation (hereinafter referred to as the “presenting file”). The presenting file generation unit 214 loads the configuration data from the configuration data storage unit 204, and generates a presenting file of an HTML format or the like. The configuration data presenting unit 212 presents the presenting file to the communication terminal 100. Accordingly, the FAX machine 200a can present a reference screen of the registered configuration data.

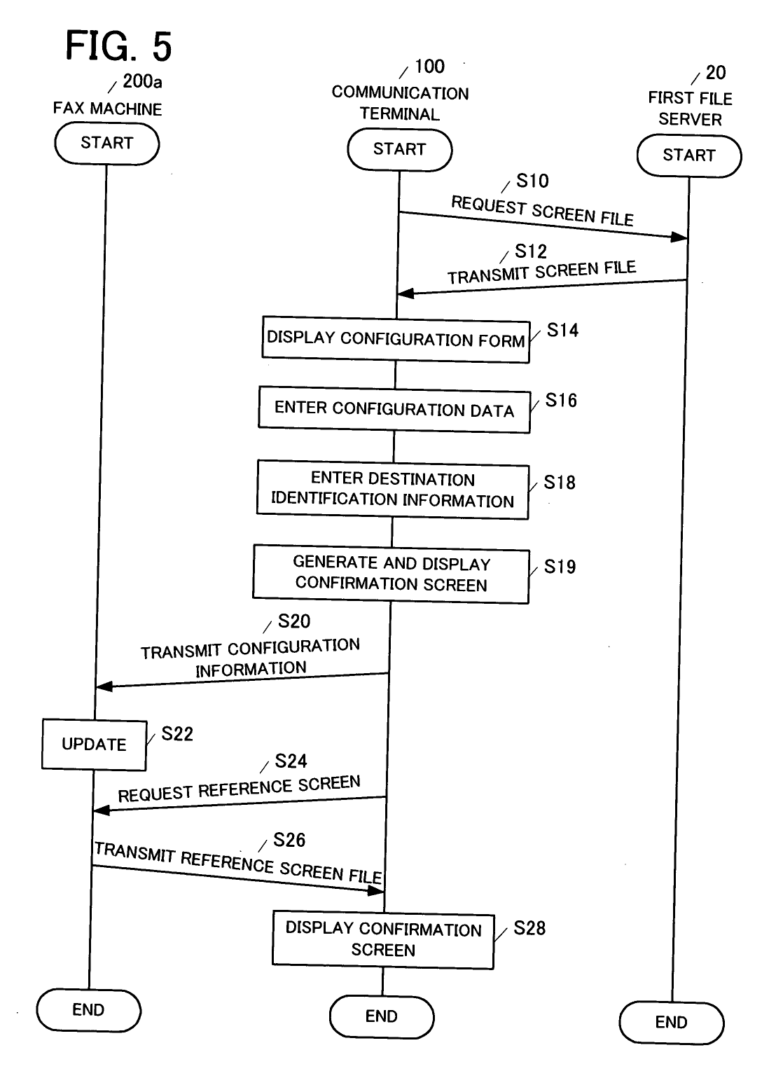

FIG. 5 is a sequence diagram of a configuration process of acquiring a screen file from the first file server 20 of FIG. 1. First, the communication terminal 100 requests a screen file from the first file server 20 (step S10). The first file server 20 transmits a screen file according to the request (step S12). Next, the communication terminal 100 displays the configuration screen 50 in accordance with the acquired screen file (step S14). Then, the communication terminal 100 accepts an entry of the configuration data from the user (step S16), and an entry of the destination identification information (step S18). In accordance with the configuration data input from the configuration screen 50, a confirmation screen 62 is generated and displayed (step S19). Consequently, the communication terminal 100 transmits the configuration information to the FAX machine 200a designated as the destination in accordance with a transmission instruction from the confirmation screen 62 (step S20).

The FAX machine 200a which received the configuration information updates the data for each data item in accordance with the configuration information (step S22). Then, the communication terminal 100 requests a reference screen of the configuration data (step S24). The FAX machine 200a transmits a reference screen file including the registered configuration data to the communication terminal 100 (step S26). Then, the communication terminal 100 displays the reference screen in accordance with the reference screen file (step S28).

The foregoing invention has been described in terms of preferred embodiment. However, those skilled in the art will recognize that many variations of such an embodiment exist. Such variations are intended to be within the scope of the present invention and the appended claims.

For example, as a second embodiment, the configuration information accepting unit 208 of FIG. 4 can store in advance, other electronic mail addresses not grasped by the user. Then, a service person in charge of the FAX machine 200a can transmit an electronic mail message including detailed configuration data to the electronic mail address. Accordingly, the service person can change the configuration or carry out maintenance work in a background not recognized by the user, and the FAX machine 200a can be maintained in an optimum state at all the times without the user being conscious of the arrangement.

As a third embodiment, the analyzing unit 210 of FIG. 4 can include a function for selectively fetching only necessary configuration data from the configuration information. For example, when a first machine requires five data items, and a second machine requires three data items among the five data items, the analyzing unit 210 of the second machine can fetch the configuration data corresponding to the three data items which are necessary for the configuration from the five configuration data items included in the configuration information. Accordingly, for example, one screen file can be used by a plurality of machines.

As a fourth embodiment, a field like the entry fields 56 of FIG. 2 in the configuration screen for accepting an entry from the user is not provided, so that only the destination information entry field 58 can be provided. The screen file for generating the configuration screen can include configuration data intended to be set in advance by using “hidden” or the like in the HTML. Accordingly, it becomes necessary for the user to designate only the destination.

As a fifth embodiment, the first file server 20 and the second file server 22 of FIG. 1 can carry out a certification, and in accordance with the result, a screen file can be selected and presented to the communication terminal 100. For example, a user and a service person can be distinguished by an ID and a password, and a screen file for users can be presented to the user, and a screen file for service persons can be presented to the service person.

As a sixth embodiment, the screen file can include a default value as an initial value. When there is a configuration item which is common for a plurality of prescribed apparatus, the efficiency in the configuration operation can be improved.

As a seventh embodiment, a user specifying unit can be provided, and the screen file can be customized according to the user. A screen including the configuration item according to an end user or a maintenance worker can be presented.

What is claimed is:

1. A communication terminal device comprising:
means for accepting a screen file for displaying a configuration screen having a configuration data entry field;
means for accepting configuration data for setting a prescribed apparatus in the configuration data entry field;
means for accepting information for specifying the prescribed apparatus intended to set the configuration data, as destination identification information; and
means for transmitting the configuration data to an apparatus specified by the destination identification information.

2. The communication terminal device according to claim 1, wherein the means for accepting the destination identification information accepts an entry of an electronic mail address of an electronic mail message which can be acquired by the prescribed apparatus, and the means for transmitting transmits an electronic mail message including the configuration data to the electronic mail address.

3. A communication terminal device comprising:
a screen file accepting unit which accepts a screen file for displaying a configuration screen having a configuration data entry field;
a configuration data accepting unit which accepts configuration data for setting a prescribed apparatus in the configuration data entry field;
a destination accepting unit which accepts information for specifying the prescribed apparatus intended to set the configuration data, as destination identification information; and
a transmission unit which transmits the configuration data to an apparatus specified by the destination identification information.

4. The communication terminal device according to claim 3, further comprising:
a confirmation screen generation unit which generates a confirmation screen for confirming the configuration data and/or the destination identification information accepted by the configuration data accepting unit and/or the destination accepting unit.

5. The communication terminal device according to claim 3, wherein the screen file accepting unit accepts the screen file from a remote recording medium.

6. The communication terminal device according to claim 3, wherein the screen file accepting unit accepts the screen file from other than the prescribed apparatus via a communication network.

7. The communication terminal device according to claim 3, wherein the screen file includes a default value in a configuration data entry field.

8. The communication terminal device according to claim 3, further comprising:
a user specifying unit which specifies a user; and
a customize unit which customizes the screen file in accordance with a result of the specification.

9. The communication terminal device according to claim 3, wherein the destination accepting unit accepts an entry of an electronic mail address of an electronic mail message which can be acquired by the prescribed apparatus, and the transmission unit transmits an electronic mail message including the configuration data to the electronic mail address.

10. The communication terminal device according to claim 9, wherein the electronic mail address is an electronic mail address exclusive for maintenance.

11. The communication terminal device according to claim 3, wherein the destination accepting unit accepts an entry of a Uniform Resource Locator (URL) which can be acquired by the prescribed apparatus, and the transmission unit transmits the configuration data to the URL.

12. A configuration method comprising:
accepting a file for displaying a configuration screen to be used for configuring a prescribed apparatus;
accepting an entry of configuration data to be set in the prescribed apparatus by following the configuration screen;
accepting information for specifying the prescribed apparatus intended to set the configuration data, as destination identification information; and
transmitting the configuration data to an apparatus specified by the destination identification information.

13. The configuration method according to claim 12, further comprising:
generating a confirmation screen for confirming the accepted configuration data and/or the destination identification information.
